(19) United States
(12) Patent Application Publication
(10) Pub. No.: US 2026/0164222 A1
(43) Pub. Date: Jun. 11, 2026

(54) SYSTEM AND METHOD TO TEST AN EMERGENCY SYSTEM

(71) Applicant: DISH Wireless L.L.C., Englewood, CO (US)

(72) Inventor: Jeffrey Lang McSchooler, Parker, CO (US)

(21) Appl. No.: 18/971,993

(22) Filed: Dec. 6, 2024

(51) Int. Cl. H04W 4/90; H04W 4/02; H04W 24/10

(52) U.S. Cl. CPC H04W 4/90; H04W 4/025; H04W 24/10

(57) ABSTRACT

A first measurement report transmitted by a first user equipment (UE) is received. In response to determining that a first location report corresponding to the first measurement report and including a first geographical address of the UE is not received within a preconfigured time period from receiving the first measurement report, it is determined that an over the top (OTT) server responsible to generate the first location report has experienced an anomaly. In response to determining that the OTT server has experienced an anomaly an alert message is generated and transmitted to a service node.

### TECHNICAL FIELD

The present disclosure relates generally to wireless communications, and more specifically to a system and method to test an emergency system.

### BACKGROUND

One of the primary challenges in providing emergency services to a wireless caller is to determine a location of the wireless caller quickly and accurately so that emergency services can be swiftly dispatched to the location of the wireless caller. In conventional emergency systems, when a wireless caller uses a User Equipment (e.g., cell phone) to place a wireless emergency call to an emergency phone number (e.g., 911), the network operator of the cellular network is responsible to provide the location of the calling UE which is then used to route the wireless emergency call to the closest public safety answering point (PSAP) and to dispatch emergency services to the provided location of the UE. Malfunctioning equipment can cause the network operator to not provide the location of the calling UE, provide a delayed location of the calling UE, and/or provide an incorrect location of the calling UE.

### SUMMARY

The system as disclosed in the present disclosure provide for detecting anomalies/malfunction associated with determining and/or providing location of a wireless emergency caller. The disclosed system and methods provide several practical applications and technical advantages. For example, the disclosed system provides the practical application of promptly detecting and resolving a malfunction associated with an over the top (OTT) server that is responsible to provide a geographical location of a user equipment (UE) calling into the emergency service network.

In conventional emergency systems, when a wireless caller uses a UE to place a wireless emergency call to an emergency phone number (e.g., 911), the network operator of the cellular network is responsible to provide the location of the calling UE which is then used to route the wireless emergency call to the closest PSAP and to dispatch emergency services to the provided location of the UE. Generally, an OTT server operated by the network operator receives measurement reports from a calling UE and transmits a corresponding location report to an emergency server, wherein the emergency server, based on the location report, routes the wireless emergency call to a PSAP nearest to the geographical address of the UE and further forwards the geographical address of the UE to the PSAP for dispatching emergency services. However, in some cases, the OTT server provides an incorrect or inaccurate location of the UE because of a software or hardware malfunction at the OTT server. In some cases, the OTT server is unable to provide the geographical address at all as a result of OTT server failure. For example, a malfunctioning OTT server may suffer from slower processing of data causing slower response times. This may cause slower processing of measurement reports and generation of corresponding location reports that are transmitted to the emergency server. This may be a problem when the wireless caller is moving (e.g., in a vehicle) as the location reports received by the emergency server may not represent the most recent location of the UE. A location report including an incorrect location of the UE may cause the wireless emergency call to be routed to a wrong PSAP needing further re-routing of the wireless emergency call to the correct PSAP delaying dispatch of emergency services. In another example, a failed OTT server causes similar issues. For example, a failed OTT server may not transmit location reports to the emergency server. In such a case, a live agent will need to receive the wireless emergency call, determine the location of the wireless caller via oral communication, and appropriately route the call to a PSAP. This delay in routing the wireless emergency call to the correct PSAP causes a delay in dispatching emergency services resulting in delays in the wireless caller receiving the required emergency care.

In conventional systems, such a malfunction or failure of the OTT server is detected only during an active wireless emergency call, for example, when the emergency server does not receive a location report from the OTT server or receives an incorrect/inaccurate geographical address of the calling UE resulting in routing of the wireless emergency call to a wrong PSAP and/or dispatching of emergency services to an incorrect address. Once a malfunction is detected in the operation of the OTT server, the malfunction is investigated and resolved. However, this reactive approach to detection and resolution of anomalies related to the OTT server is not ideal and often results in lower performance of the OTT server and, as a result, the emergency service network for extended time periods, for example, because of delayed detection of malfunctions associated with the OTT server.

The disclosed system and method determine a malfunction at the OTT server proactively and promptly so that any determined anomalies may be resolved quickly. As described in embodiments of the present disclosure, a test UE is configured to periodically place a wireless emergency test call to test location-based routing of wireless emergency calls. A wireless emergency test call is placed by dialing an emergency test number (e.g., 522) that is different from the emergency number (e.g., 911) used to place wireless emergency calls. An emergency test call is routed to a PSAP just like a wireless emergency call is routed but does not result in dispatch of emergency services. As described in embodiments of the present disclosure, a malfunction and/or failure of the OTT server may be detected by tracking the location-based routing of a wireless emergency test calls. Test UEs are configured to place wireless emergency test calls often enough (e.g., periodically) such that a malfunction/failure of the OTT server is detected proactively and promptly allowing for quicker resolution of any detected issues at the OTT server. Promptly resolving performance issues related to the OTT server results in improved performance of the OTT server and overall improved performance of the emergency service network. For example, prompt detection and resolution of a malfunction associated with the OTT server may result in a lower downtime of the OTT server. Additionally, proactively detecting and resolving malfunctions related to the OTT server before a wireless emergency call is placed increases the likelihood that accurate location reports are reliably sent to the emergency server thus avoiding delays in assignment of a PSAP to the wireless emergency call and dispatch of emergency services to the location of a wireless caller.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with one embodiment of the present disclosure; and

FIG. 2 is a flowchart of an example method for testing location-based routing of emergency calls, in accordance with one embodiment of the present disclosure.

### DETAILED DESCRIPTION

### System Overview

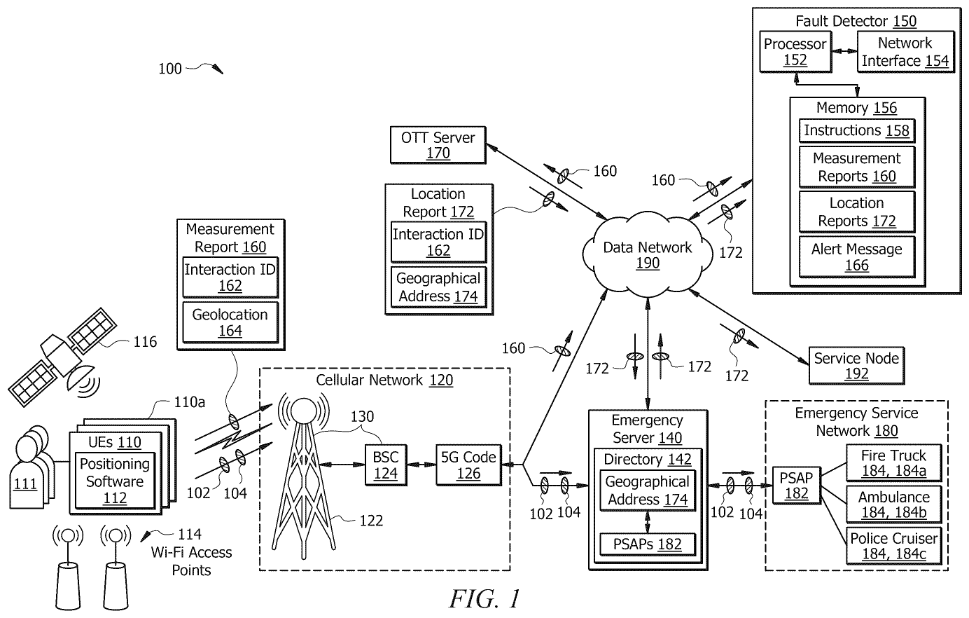

FIG. 1 is a schematic diagram of a system 100, in accordance with one embodiment of the present disclosure. As shown in FIG. 1, system 100 includes a cellular network 120, an emergency server 140, and an emergency service network 180, an over the top (OTT) server 170, a fault detector 150, and a service node 192 connected to a data network 190.

The cellular network 120 may include a base station tower 122, a base station controller (BSC) 124, and a 5G core 126. Collectively, base station tower 122 and base station controller 124 may be referred to as a base station 130. A base station tower 122, often also referred to as a cell tower, is a fixed radio transceiver that is capable of sending and receiving wireless signals and is the main communication point for user equipment (UEs) 110. It may be noted that the terms “base station tower”, “cell tower” and “tower” may be used interchangeably throughout this disclosure. BSC 124 is a network element that typically controls and monitors several base station towers 122 and provides an interface between a tower 122 and a mobile switching center (not shown). In the context of 5^{th} Generation (5G) New Radio (NR), base station 130 may be referred to as a gNodeB or gNB. It may be noted that the terms “base station” and “gNodeB” may be used interchangeably throughout this disclosure. Base station 130 may provide a UE 110 access to the 5G core 126. For example, base station 130 may be part of a 5G NR cellular network. In this context, base station 130 may be a gNodeB. Base station 130 may serve a particular geographical area, with other base stations serving neighboring geographical areas that at least partially overlap. Services provided by the cellular network 120 can include telephone calls, network access (e.g., access to a data network 190 such as the Internet), data reporting, text messaging services, etc. For example, the 5G core 126 of the cellular network 120 connects UEs 110 to the data network 190. Such services may generally rely on packetized data being exchanged between the UE 110 and the base station 130.

While cellular network 120 is described in the context of a 5G NR radio network that uses gNodeBs as base stations 130, the embodiments detailed herein can be applicable to other types of cellular networks, such as a 4G Long Term Evolution (LTE) cellular network, that uses eNodeBs in place of gNodeBs. In one or more embodiments, cellular network 120 operates according to the 5G NR radio access technology (RAT). In other embodiments, a different RAT may be used, such as 3G, 4G Long Term Evolution (LTE), or some other RAT. In some other embodiments, as shown in FIG. 1, the 5G network may use a 5G core 126. In some embodiments, a 5G network may use an evolved packet core (EPC) instead of or in addition to the 5G core 126. Communications from base station tower 122 to UE 110 may be scheduled. Various physical resource blocks (PRBs) may be available across multiple component carriers (CCs) of a carrier aggregation (CA) for communication. Each PRB may define a timeslot on a particular frequency within a CC. The number of PRBs available on a given CC is dependent on the bandwidth of the CC and the subcarrier spacing of the CC.

Each UE 110 may be one of various forms of wireless devices that are capable of communication according to the radio access technology (RAT) of the cellular network 120. For instance, a UE 110 can be a smartphone, wireless modem, cellular phone, laptop computer, wireless access point (APs), etc.

Data network 190, in general, may be a wide area network (WAN), a personal area network (PAN), a cellular network, or any other technology that allows devices to communicate electronically with other devices. In one or more embodiments, data network 190 may be the Internet.

The emergency service network 180 generally includes a plurality of public safety answering points (PSAPs). One such example PSAP 182 is shown in FIG. 1. A PSAP 182 is a call center where emergency calls initiated by a landline or mobile device (e.g., UE 110) are received. An example emergency service network 180 may include the 9-1-1 emergency service network that is used in United States and other countries across the globe. For example, several countries have their own version of the 9-1-1 emergency network to provide emergency services to their residents. The emergency service network 180 may have several PSAPs 182 deployed across a region (e.g., country), wherein each PSAP 182 serves a particular city, town, county, village, municipality or portions thereof and attends to emergency calls made from a location within a service area of the PSAP 182. For example, the United States has over 5000 PSAPs 182 spread across the nation. Callers needing emergency services call an emergency telephone number that is common across all PSAPs 182. Example emergency numbers include 911 and 112 used in North American countries. Usually, emergency calls made to the common emergency telephone number are received at an emergency server 140 which is responsible to route the call to a PSAP 182 that is nearest to the caller's physical location/address. For example, each PSAP 182 is mapped to geographical addresses 174 within the service area of the PSAP 182, wherein all emergency calls (e.g., wireless emergency calls 102 or wireless emergency test calls 104) originating from within the service area of the PSAP 182 are to be routed to the PSAP 182 mapped to the service area. Additionally, each PSAP 182 has a unique telephone number that may be used to reach the PSAP 182.

When a wireless caller 111 uses a UE 110 to place an emergency call (e.g., wireless emergency call 102) to the common emergency telephone number (e.g., 911), a positioning software 112 running at the UE 110 determines a geolocation 164 of the UE 110 and generates a measurement report 160 including the determined geolocation 164 of UE 110. The UE 110 transmits the measurement report 160 via the data network 190 to an over-the-top (OTT) server 170 that generates a location report 172 based on the measurement report 160 received from the UE 110, wherein the location report includes a geographical address 174 of the UE 110 at the time the measurement report 160 was generated by the UE 110. The OTT server 170 is generally owned and/or managed by the network operator of the cellular network 120 and is configured to provide the geographical address 174 of UEs 110 calling into the emergency service network 180, wherein the geographical address 174 of the UEs 110 is used to select a particular PSAP 182 that receives the emergency call and dispatch emergency services 184 to the geographical address 174 of the UE 110. For example, the OTT server 170 transmits the location report 172 associated with a calling UE 110 to the emergency server 140 via the data network 190. The emergency server 140 maintains a directory 142 of mappings between geographical addresses 174 and closest PSAPs 182. The emergency server 140 looks up the directory 142 and identifies a PSAP 182 that is mapped to the particular geographical address 174 received in the location report 172. The emergency server 140 then routes the emergency call (e.g., wireless emergency call 102) to the identified PSAP 182 by connecting/forwarding the emergency call to the particular telephone number of the identified PSAP 182. In addition, the emergency server 140 forwards to the PSAP 182 the geographical address 174 of the UE 110 received in the location report 172. An emergency dispatcher at the PSAP 182 receives the emergency call and dispatches one or more emergency services 184 to the location of the wireless caller 111 as indicated by the geographical address 174 of the UE 110 received from the emergency server 140. Example emergency services 184 may include one or more fire trucks 184a, one or more ambulances 184b, one or more police cars/cruisers 184c or combinations thereof. It may be noted that the emergency server 140 may be a stand-alone entity or may be integrated with the cellular network 120. For example, the automatic location based call routing service provided by the emergency server 140 may be provided by a third-party provider or by an operator of the cellular network 120.

One of the primary challenges in providing emergency service to a wireless caller 111 is to determine a location of the wireless caller 111 quickly and accurately so that emergency services 184 can be swiftly dispatched to the location of the wireless caller 111. In conventional emergency systems, when a wireless caller 111 uses a UE 110 to place a wireless emergency call 102 to the emergency phone number (e.g., 911), the network operator of the cellular network 120 is responsible to provide the location of the calling UE 110 which is then used to route the wireless emergency call 102 to the closest PSAP 182 and to dispatch emergency services 184 to the provided location of the UE 110. As described above, an OTT server 170 operated by the network operator receives measurement reports 160 from a calling UE 110 and transmits a corresponding location report 172 to the emergency server 140, wherein the emergency server 140, based on the location report 172, routes the wireless emergency call 102 to a PSAP 182 nearest to the geographical address 174 of the UE 110 and further forwards the geographical address 174 of the UE 110 to the PSAP 182 for dispatching emergency services 184. However, in some cases, the OTT server 170 provides an incorrect or inaccurate location of the UE 110 because of a software or hardware malfunction at the OTT server 170. In some cases, the OTT server 170 is unable to provide the geographical address 174 at all as a result of OTT server failure. For example, a malfunctioning OTT server 170 may suffer from slower processing of data causing slower response times. This may cause slower processing of measurement reports 160 and generation of corresponding location reports 172 that are transmitted to the emergency server 140. This may be a problem when the wireless caller 111 is moving (e.g., in a vehicle) as the location reports 172 received by the emergency server 140 may not represent the most recent location of the UE 110. A location report 172 including an incorrect location of the UE 110 may cause the wireless emergency call 102 to be routed to a wrong PSAP 182 needing further re-routing of the wireless emergency call 102 to the correct PSAP 182 delaying dispatch of emergency services 184. In another example, a failed OTT server 170 causes similar issues. For example, a failed OTT server 170 may not transmit location reports 172 to the emergency server 140. In such a case, a live agent will need to receive the wireless emergency call 102, determine the location of the wireless caller 111 via oral communication, and appropriately route the call to a PSAP 182. This delay in routing the wireless emergency call to the correct PSAP 182 causes a delay in dispatching emergency services 184 resulting in delays in the wireless caller 111 receiving the required emergency care.

In most cases, such a malfunction or failure of the OTT server 170 is detected only during an active wireless emergency call 102, for example, when the emergency server 140 does not receive a location report 172 from the OTT server 170 or receives an incorrect/inaccurate geographical address 174 of the calling UE 110 resulting in routing of the wireless emergency call 102 to a wrong PSAP 182 and/or dispatching of emergency services 184 to an incorrect address. Once a malfunction is detected in the operation of the OTT server 170, the malfunction is investigated and resolved. However, this reactive approach to detection and resolution of anomalies related to the OTT server 170 is not ideal and often results in lower performance of the OTT server 170 and, as a result, the emergency service network 180 for extended time periods, for example, because of delayed detection of malfunctions associated with the OTT server 170.

Embodiments of the present disclosure describe techniques to proactively determine a malfunction at the OTT server 170. As further described in more detail, a test UE is configured to periodically place a wireless emergency test call 104 to test location-based routing of wireless emergency calls 102. A wireless emergency test call 104 is placed by dialing an emergency test number (e.g., 522) that is different from the emergency number (e.g., 911) used to place wireless emergency calls 102. An emergency test call 104 is routed to a PSAP 182 just like a wireless emergency call 102 is routed but does not result in dispatch of emergency services 184. As described in embodiments of the present disclosure, a malfunction and/or failure of the OTT server 170 may be detected by tracking the location-based routing of a wireless emergency test calls 104. Test UEs 110 are configured to place wireless emergency test calls 104 often enough (e.g., periodically) such that a malfunction/failure of the OTT server 170 is detected proactively and promptly allowing for quicker resolution of any detected issues at the OTT server 170. Promptly resolving performance issues related to the OTT server 170 results in improved performance of the OTT server 170 and overall improved in the performance of the emergency service network 180. For example, prompt detection and resolution of a malfunction associated with the OTT server 170 may result in a lower downtime of the OTT server 170. Additionally, proactively detecting and resolving malfunctions related to the OTT server 170 before a wireless emergency call 102 is placed increases the likelihood that accurate location reports 172 are reliably sent to the emergency server 140 thus avoiding delays in assignment of a PSAP 182 to the wireless emergency call 102 and dispatch of emergency services 184 to the location of a wireless caller 111.

In certain embodiments of the present disclosure, the fault detector 150 may be implemented by the network operator of the cellular network 120, wherein the fault detector 150 is configured to proactively detect anomalies and/or failure in the operation of the OTT server 170. The fault detector 150 includes a processor 152, a memory 156, and a network interface 154. The fault detector 150 may be configured as shown in FIG. 1 or in any other suitable configuration.

The processor 152 includes one or more processors operably coupled to the memory 156. The processor 152 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 152 may be a programmable logic device, a microcontroller, a microprocessor, or any suitable combination of the preceding. The processor 152 is communicatively coupled to and in signal communication with the memory 156. The one or more processors are configured to process data and may be implemented in hardware or software. For example, the processor 152 may be 8-bit, 16-bit, 32-bit, 64-bit or of any other suitable architecture. The processor 152 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

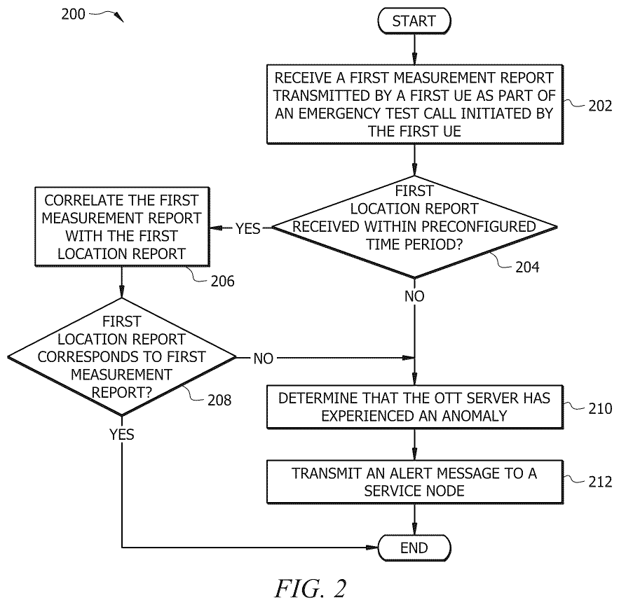

The one or more processors are configured to implement various instructions, such as software instructions. For example, the one or more processors are configured to execute instructions 158 to implement the fault detector 150. In this way, processor 152 may be a special-purpose computer designed to implement the functions disclosed herein. In one or more embodiments, the fault detector 150 is implemented using logic units, FPGAs, ASICs, DSPs, or any other suitable hardware. The fault detector 150 is configured to operate as described with reference to FIG. 2. For example, the processor 152 may be configured to perform at least a portion of method 200 as described with reference to FIG. 2.

The memory 156 includes a non-transitory computer-readable medium such as one or more disks, tape drives, or solid-state drives, and may be used as an over-flow data storage device, to store programs when such programs are selected for execution, and to store instructions and data that are read during program execution. The memory 156 may be volatile or non-volatile and may include a read-only memory (ROM), random-access memory (RAM), ternary content-addressable memory (TCAM), dynamic random-access memory (DRAM), and static random-access memory (SRAM).

The memory 156 is operable to store the instructions 158, measurement reports 160 generated by UEs 110, location reports 172 generated by the OTT server 170, alert messages 166 generated by the fault detector 150, and any other data needed to performed operations of the fault detector 150 as described in embodiments of the present disclosure. The instructions 158 may include any suitable set of instructions, logic, rules, or code operable to execute the fault detector 150.

The network interface 154 is configured to enable wired and/or wireless communications. The network interface 154 is configured to communicate data between the fault detector 150 and other devices, systems, or domains (e.g., UEs 110, 5G core 126, OTT server 170, emergency server 140, PSAPs 182, service node 192 etc.). For example, the network interface 154 may include a Wi-Fi interface, a LAN interface, a WAN interface, a modem, a switch, or a router. The processor 152 is configured to send and receive data using the network interface 154. The network interface 154 may be configured to use any suitable type of communication protocol as would be appreciated by one of ordinary skill in the art.

It may be noted that each of the UEs 110, OTT server 170, emergency server 140, PSAPs 182, and service node 192 may be implemented like the fault detector 150 shown in FIG. 1. For example, each of the UEs 110, OTT server 170, emergency server 140, PSAPs 182, and service node 192 may have a respective processor and a memory that stores data and instructions to perform a respective functionality of each of the UEs 110, OTT server 170, emergency server 140, PSAPs 182, and service node 192.

In one or more embodiments, when a wireless emergency call 102 or a wireless emergency test call 104 is placed using a UE 110 (e.g., by dialing an emergency number or an emergency test number respectively), the UE 110 is configured to generate a measurement report 160 that indicates a geolocation 164 of the UE 110. For example, when a wireless caller 111 uses a UE 110 to place a wireless emergency call 102 (by dialing emergency telephone number such as 911) or places a wireless emergency test call 104 (by dialing emergency test telephone number such as 522), a positioning software 112 at the UE 110 determines a geolocation 164 of the UE 110 and generates a measurement report 160 including the determined geolocation 164 of the UE 110. The UE 110 may determine the geolocation 164 of the UE 110 by performing global positioning system (GPS) positioning using a GPS device, by performing radio location with one or more cell towers 122, by performing Wi-Fi positioning with one or more Wi-Fi access points 114, or combinations thereof. In one embodiment, the geolocation 164 of the UE 110 may include (x, y) coordinates, wherein the x-coordinate is measured along the east-west axis and represents a latitude position and the y-coordinate is measured along the north-south axis and represents a longitude position. In additional or alternative embodiments, the geolocation 164 of the UE 110 may include (x, y, z) coordinates where the x-coordinate is measured along the east-west axis and represents a latitude position, the y-coordinate is measured along the north-south axis and represents a longitude position, and the z-coordinate represents height or elevation.

In one embodiment, a UE 110 may include a GPS device/sensor that is configured to capture and provide information relating to the geolocation 164 of the UE 110 based on interaction with one or more GPS satellites 116. The GPS device/sensor may be configured to provide the geolocation 164 information as a relative geographic location or an absolute geographic location. For example, the GPS device may provide the geolocation 164 information using geographic coordinates (i.e., longitude and latitude) or any other suitable coordinate system. In an additional or alternative embodiment, a UE 110 may be configured to determine the geolocation 164 of the UE 110 by performing radiolocation using a radio transceiver of the UE 110. Radiolocation generally is the process of finding a geographical location of an object using radio waves. Radiolocation is used in cellular telephony via cell towers 122. Several radiolocation methods may be used to determine geolocation 164 of the UE 110 including, but not limited to trilateration, multilateration, triangulation or combinations thereof. In an additional or alternative embodiment, a UE 110 may be configured to determine the geolocation 164 of the UE 110 by performing Wi-Fi positioning using nearby Wi-Fi access points 114. Wi-Fi positioning system (WPS) is a geolocation system that uses the characteristics of nearby Wi-Fi hotspots and other wireless access points 114 to discover where a device (e.g., UE 110) is located. Determining geolocation 164 of the UE 110 using Wi-Fi positioning generally includes measuring the intensity of signals received from one or more nearby Wi-Fi access points 114 and determining a geolocation 164 of the UE 110 by correlating the signal strengths with known positions of the Wi-Fi access points. Once a geolocation 164 is determined, the UE 110 generates a measurement report 160 that includes a unique interaction ID 162 of the particular measurement report 160 and the determined geolocation 164 of the UE 110. As described above, the UE 110 is configured to transmit the measurement report 160 via the data network 190 to the OTT server 170. In one embodiment, once a wireless emergency call 102 or a wireless emergency test call 104 is initiated, the UE 110 (e.g., using the positioning software 112) is configured to generate and transmit measurement reports periodically, wherein each measurement report 160 includes a respective interaction ID 162 uniquely identifying the measurement report 160 and a most recent geolocation 164 determined by the UE 110.

In one or more embodiments, one or more of the UEs 110 is a test UE 110a that is configured to periodically place a wireless emergency test call 104 to test any anomalies associated with location-based routing of wireless emergency calls 102 to PSAPs 182. For example, the network operator of the cellular network 120 may implement a plurality of test UEs 110a across the cellular network (e.g., one test UE in the service area of each PSAP 182). In one embodiment a test UE 110a is configured to periodically (e.g., every 15 mins) initiate a wireless emergency test call 104 by dialing an emergency test number (e.g., 522) and hold each wireless emergency test call 104 active for a preconfigured duration (e.g., 2 mins). As described above, an emergency test call 104 is handled just like an emergency call 102 but does not result in dispatch of emergency services 184 to the location of the test UE 110a. For example, like in the case of an emergency call 102, an emergency test call 104 is routed to a PSAP 182. However, unlike a regular emergency call 102, the PSAP 182 receiving the emergency test call 104 does not dispatch emergency services 184 to the location of the test UE 110a that placed the emergency test call 104.

When a test UE 110a initiates a wireless emergency test call 104 (e.g., by dialing the emergency test number such as 522), the positioning software 112 installed at the test UE 110a detects that the emergency test call 104 has been initiated and, in response, starts the process of determining geolocation 164 of the UE 110 and periodically transmitting measurement reports 160 to the OTT server 170, each measurement report 160 including a most recent geolocation 164 of the UE 110 and a unique interaction ID 162. In one embodiment, upon detecting that the test UE 110a has initiated a wireless emergency test call 104, the cellular network 120 (e.g., 5G core 126 of the cellular network 120) intercepts each measurement report 160 transiting the cellular network 120 (e.g., on its way to OTT server 170) and transmits (e.g., via the data network 190) a copy of each measurement report 160 to the fault detector 150 in real time. In an alternative or additional embodiment, the test UE 110a, in addition to transmitting each measurement report 160 to the OTT server 170, may be configured to additionally transmit a copy of each measurement report 160 to the fault detector 150, in response to detecting that the test UE 110a has initiated the wireless emergency test call 104.

Like in the case of a regular wireless emergency call 102 initiated by a UE 110, the OTT server 170 may be configured to generate a location report 172 corresponding to each measurement report 160 received from the test UE 110a and transmit each location report 172 via the data network 190 to the emergency server 140. Each location report 172 generated and transmitted by the OTT server 170 includes a geographical address 174 of the test UE 110a generated based on the geolocation 164 included in the corresponding measurement report 160. Thus, each location report 172 includes a geographical address 174 of the test UE 110a at the time the respective measurement report 160 was generated by the test UE 110. The term “geographical address 174” in the context of the present disclosure may represent a location of the test UE 110a on a geographical map of the city, state, or county etc. in which the test UE 110a is located. For example, the geographical address 174 may be “1234 XYZ street, Houston, Texas”. In one embodiment, the OTT server 170 may generate a geographical address 174 of the test UE 110a by mapping a geolocation 164 of the test UE 110a (e.g., received in a respective measurement report 160) on a geographical map of the city, state, or county etc. in which the test UE 110a is located. The OTT server 170 may be configured to use other pieces of data such as the address of the cell tower 122 to which the test UE 110a is connected to determine the geographical address 174 of the test UE 110a. In one embodiment, in each location report 172, the OTT server 170 may be configured to include the same interaction ID 162 of the respective measurement report 160 based on which the location report 172 is generated. In other words, the interaction ID 162 included in each location report 172 is same as the interaction ID 162 included in the measurement report 160 received from the test UE 110a based on which the location report 172 was generated.

In one or more embodiments, upon determining that a location report 172 received from the OTT server 170 is associated with a wireless emergency test call 104, the emergency server 140 may be configured to transmit a copy of the location report 172 to the fault detector 150 in real time. Thus, a copy of each location report 172 received from the OTT server 170 that relates to the wireless emergency test call 104 placed by the test UE 110a is forwarded to the fault detector 150 via the data network 190 in real time. In one embodiment, upon receiving a first location report 172 after initiation of the wireless emergency test call 104 by the test UE 110a, the emergency server 140 may also determine a PSAP 182 based on the geographical address 174 of the test UE 110a included in the location report 172 and forward the emergency test call 104 to the determined PSAP 182.

The fault detector 150 may be configured to proactively detect anomalies and/or failure in the operation of the OTT server 170. For example, upon receiving a measurement report 160 transmitted by a test UE 110a, the fault detector 150 may determine that a wireless emergency test call 104 has been initiated by the test UE 110a. In one embodiment, a measurement report 160 may include a unique identification of the test UE 110a that placed the wireless emergency test call 104 which allows the fault detector 150 to distinguish between measurement reports 160 transmitted by different test UEs 110a. The fault detector 150 may be configured to perform several tests to determine whether the OTT server 170 is malfunctioning. In one embodiment, upon receiving a measurement report 160 transmitted by a test UE 110a, the fault detector 150 may be configured to determine whether a corresponding location report 172 is received within a pre-configured time period from receiving the measurement report 160. As described above, the cellular network 120 (e.g., 5G core 126) forwards in real time a copy of each measurement report 160 transmitted by a test UE 110a to the fault detector 150. Further, a copy of each location report 172 relating to the test UE 110a is forwarded in real time by the emergency server 140 to the fault detector 150. In response to determining that a location report 172 is not received by the fault detector 150 in the pre-configured time period from receiving a measurement report 160, the fault detector 150 may be configured to determine that the OTT server 170 has experienced an anomaly. The pre-configured time period may be set to an average time period a normally functioning OTT server 170 takes to generate a location report 172 based on a respective measurement report 160. Not receiving a location report 172 in the pre-configured time period from receiving a measurement report 160 indicates that the OTT server 170 could not generate a location report 172 in the usual time period it takes the OTT server 170 to generate a location report 172 based on a measurement report 160, thus indicating that the OTT server 170 has potentially experienced an anomaly. For example, a malfunctioning OTT server 170 may cause slow processing and thus slow response times at the OTT server 170 resulting in the OTT server 170 not being able to generate and transmit a location report 172 within the pre-configured time period from receiving a respective measurement report 160. In another example, a failed OTT server 170 may also result in the OTT server 170 not being able to generate and transmit a location report 172 within the pre-configured time period from receiving a respective measurement report 160.

In an additional or alternative embodiment, when the fault detector 150 receives a location report 172 within the pre-configured time period from receiving a measurement report 160, the fault detector 150 may be configured to correlate the location report 172 with the measurement report 160 and determine whether the OTT server 170 has experienced an anomaly based on the correlation. For example, the fault detector 150 may correlate the location report 172 with the measurement report 160 to determine whether the location report 172 was generated based on the measurement report 160. Correlating the location report 172 with the measurement report 160 may include extracting the interaction IDs 162 from the location report 172 and the measurement report 160 and comparing the extracted interaction IDs 162 to determine whether both the location report 172 and the measurement report 160 include the same interaction ID 162. As described above, the OTT server 170 includes the same interaction ID 162 of the respective measurement report 160 based on which the location report 172 is generated. Thus, matching interaction IDs 162 between the location report 172 and the measurement report 160 indicates that the location report 172 was generated based on the measurement report 160. Thus, when the location report 172 and the measurement report 160 are found to include the same interaction ID 162, the fault detector 150 determines that the location report 172 was generated based on the measurement report 160. On the other hand, when the location report 172 and the measurement report 160 are found to include different interaction IDs 162, the fault detector 150 determines that the location report 172 was not generated based on the measurement report 160.

In one or more embodiments, in response to determining based on the correlation of the location report 172 with the measurement report 160 that the location report 172 was generated based on the measurement report 160, the fault detector 150 may be configured to determine that the OTT server 170 is operating normally. On the other hand, in response to determining based on the correlation that the location report 172 was not generated based on the measurement report 160, the fault detector 150 may be configured to determine that the OTT server 170 has experienced an anomaly. For example, a malfunctioning OTT server 170 may cause slow processing and thus slow response times at the OTT server 170. Slow response time at the OTT server 170 may cause the OTT server 170 to generate a location report 172 after another measurement report 160 has already been transmitted by the test UE 110a. This means that the location report 172 generated by the OTT server 170 is based on an older measurement report 160 generated by the test UE 110a. Since the location report 172 is based on an older measurement report 160, the interaction ID 162 included in the location report 172 does not match with the interaction ID 162 included in the most recent measurement report 160 transmitted by the test UE 110a. Thus, a mismatch in interaction IDs 162 between a most recent measurement report 160 received at the fault detector 150 and a location report 172 received after the most recent measurement report 160 may indicate that the OTT server 170 has experienced an anomaly.

In an alternative or additional embodiment, the Fault detector 150 may be configured to determine that an anomaly has occurred at the OTT server 170 when the geographical address 174 included in a location report 172 does not match with the geolocation 164 included in the measurement report 160 based on which the location report 172 was generated. For example, in response to determining that a location report 172 was received within the pre-configured time period from a measurement report 160 and determining that interaction IDs 162 included in the location report 172 and the respective measurement report 160 match, the fault detector 150 may be configured to generate the geographical address 174 of the UE 110 based on the geolocation 164 included in the respective measurement report 160 based on which the location report 172 was generated. For example, to generate the geographical address 174, the fault detector 150 may be configured to use the same or similar method used by the OTT server 170 to generate the geographical address 174 based on the geolocation 164 included in the measurement report 160. The fault detector 150 then compares the locally generated geographical address 174 with the geographical address 174 included in the location report 172. When both geographical addresses 174 do not match, the fault detector 150 may determine that an anomaly has occurred in the operation of the OTT server 170 that caused the OTT server 170 to incorrectly determine the geographical address 174 of the test UE 110a based on the geolocation 164 received from the test UE 110a.

The fault detector 150 may be configured to generate an alert message 166 in response to determining that the OTT server 170 has experienced an anomaly. The alert message 166 may include an indication the OTT server 170 has experienced an anomaly and may further include information relating to the anomaly. For example, the fault detector 150 may include in the alert message 166 information relating to what caused the fault detector 150 to determine that the OTT server 170 is experiencing an anomaly. For example, the alert message 166 may indicate that a location report 172 was not received within the pre-configured time period from receiving a measurement report 160. In another example, the alert message 166 may indicate that the interaction IDs 162 do not match between a location report 172 and a most recent measurement report 160. The fault detector 150 may be configured to transmit alert messages 166 to a service node 192 where network technicians may be employed to investigate the nature of the anomaly at the OTT server 170 and resolve the anomaly. In an alternative or additional embodiment, the service node 192 may employ software programs that monitor and measure several performance related metrics related to the OTT server 170 and identify an anomaly based on the collected metrics. For example, the OTT server 170 may employ several sensors that are configured to measure respective metrics such as temperature, power surges, processing speed, CPU health etc. Once a particular anomaly is identified, the service node may run resolution software scripts to resolve the identified anomaly. For example, when overheating of the OTT server 170 is detected, the service node 192 may divert some data traffic to a different server to ease processing load at the OTT server 170. The reduced load may improve processing performance of the OTT server 170 and reduce heat.

FIG. 2 is a flowchart of an example method 200 for testing location-based routing of emergency calls, in accordance with one embodiment of the present disclosure. Method 200 may be performed by the fault detector 150 as shown in FIG. 1.

At operation 202, the fault detector 150 receives from a cellular network 120 via a data network 190, a first measurement report 160 transmitted by a first UE (e.g., test UE 110a) as part of an emergency test call (e.g., wireless emergency test call 104) initiated by the first UE, wherein the first measurement report 160 includes a first geolocation 164 of the first UE.

As described above, one or more of the UEs 110 is a test UE 110a that is configured to periodically place a wireless emergency test call 104 to test any anomalies associated with location-based routing of wireless emergency calls 102 to PSAPs 182. For example, the network operator of the cellular network 120 may implement a plurality of test UEs 110a across the cellular network (e.g., one test UE in the service area of each PSAP 182). In one embodiment a test UE 110a is configured to periodically (e.g., every 15 mins) initiate a wireless emergency test call 104 by dialing an emergency test number (e.g., 522) and hold each wireless emergency test call 104 active for a preconfigured duration (e.g., 2 mins). As described above, an emergency test call 104 is handled just like an emergency call 102 but does not result in dispatch of emergency services 184 to the location of the test UE 110a. For example, like in the case of an emergency call 102, an emergency test call 104 is routed to a PSAP 182. However, unlike a regular emergency call 102, the PSAP 182 receiving the emergency test call 104 does not dispatch emergency services 184 to the location of the test UE 110a that placed the emergency test call 104.

When a test UE 110a initiates a wireless emergency test call 104 (e.g., by dialing the emergency test number such as 522), the positioning software 112 installed at the test UE 110a detects that the emergency test call 104 has been initiated and, in response, starts the process of determining geolocation 164 of the UE 110 and periodically transmitting measurement reports 160 to the OTT server 170, each measurement report 160 including a most recent geolocation 164 of the UE 110 and a unique interaction ID 162. In one embodiment, upon detecting that the test UE 110a has initiated a wireless emergency test call 104, the cellular network 120 (e.g., 5G core 126 of the cellular network 120) intercepts each measurement report 160 transiting the cellular network 120 (e.g., on its way to OTT server 170) and transmits (e.g., via the data network 190) a copy of each measurement report 160 to the fault detector 150 in real time. In an alternative or additional embodiment, the test UE 110a, in addition to transmitting each measurement report 160 to the OTT server 170, may be configured to additionally transmit a copy of each measurement report 160 to the fault detector 150, in response to detecting that the test UE 110a has initiated the wireless emergency test call 104.

At operation 204, the fault detector 150 determines whether a first location report 172 corresponding to the first measurement report 160 and including a first geographical address 174 of the first UE (e.g., test UE 110a) is received from the emergency server 140 within a preconfigured time period from receiving the first measurement report 160 from the first UE. In response to determining that the first location report 172 is not received within the preconfigured time period from receiving the first measurement report 160, method 200 proceeds to operation 210 where the fault detector 150 determines that the OTT server 170 has experienced an anomaly.

As described above, like in the case of a regular wireless emergency call 102 initiated by a UE 110, the OTT server 170 may be configured to generate a location report 172 corresponding to each measurement report 160 received from the test UE 110a and transmit each location report 172 via the data network 190 to the emergency server 140. Each location report 172 generated and transmitted by the OTT server 170 includes a geographical address 174 of the test UE 110a generated based on the geolocation 164 included in the corresponding measurement report 160. Thus, each location report 172 includes a geographical address 174 of the test UE 110a at the time the respective measurement report 160 was generated by the test UE 110a. The term “geographical address 174” in the context of the present disclosure may represent a location of the test UE 110a on a geographical map of the city, state, or county etc. in which the test UE 110a is located. For example, the geographical address 174 may be “1234 XYZ street, Houston, Texas”. In one embodiment, the OTT server 170 may generate a geographical address 174 of the test UE 110a by mapping a geolocation 164 of the test UE 110a (e.g., received in a respective measurement report 160) on a geographical map of the city, state, or county etc. in which the test UE 110a is located. The OTT server 170 may be configured to use other pieces of data such as the address of the cell tower 122 to which the test UE 110a is connected to determine the geographical address 174 of the test UE 110a. In one embodiment, in each location report 172, the OTT server 170 may be configured to include the same interaction ID 162 of the respective measurement report 160 based on which the location report 172 is generated. In other words, the interaction ID 162 included in each location report 172 is same as the interaction ID 162 included in the measurement report 160 received from the test UE 110a based on which the location report 172 was generated.

In one or more embodiments, upon determining that a location report 172 received from the OTT server 170 is associated with a wireless emergency test call 104, the emergency server 140 may be configured to transmit a copy of the location report 172 to the fault detector 150 in real time. Thus, a copy of each location report 172 received from the OTT server 170 that relates to the wireless emergency test call 104 placed by the test UE 110a is forwarded to the fault detector 150 via the data network 190 in real time. In one embodiment, upon receiving a first location report 172 after initiation of the wireless emergency test call 104 by the test UE 110a, the emergency server 140 may also determine a PSAP 182 based on the geographical address 174 of the test UE 110a included in the location report 172 and forward the emergency test call 104 to the determined PSAP 182.

The fault detector 150 may be configured to proactively detect anomalies and/or failure in the operation of the OTT server 170. For example, upon receiving a measurement report 160 transmitted by a test UE 110a, the fault detector 150 may determine that a wireless emergency test call 104 has been initiated by the test UE 110a. In one embodiment, a measurement report 160 may include a unique identification of the test UE 110a that placed the wireless emergency test call 104 which allows the fault detector 150 to distinguish between measurement reports 160 transmitted by different test UEs 110a. The fault detector 150 may be configured to perform several tests to determine whether the OTT server 170 is malfunctioning. In one embodiment, upon receiving a measurement report 160 transmitted by a test UE 110a, the fault detector 150 may be configured to determine whether a corresponding location report 172 is received within a pre-configured time period from receiving the measurement report 160. As described above, the cellular network 120 (e.g., 5G core 126) forwards in real time a copy of each measurement report 160 transmitted by a test UE 110a to the fault detector 150. Further, a copy of each location report 172 relating to the test UE 110a is forwarded in real time by the emergency server 140 to the fault detector 150. In response to determining that a location report 172 is not received by the fault detector 150 in the pre-configured time period from receiving a measurement report 160, the fault detector 150 may be configured to determine that the OTT server 170 has experienced an anomaly. The pre-configured time period may be set to an average time period a normally functioning OTT server 170 takes to generate a location report 172 based on a respective measurement report 160. Not receiving a location report 172 in the pre-configured time period from receiving a measurement report 160 indicates that the OTT server 170 could not generate a location report 172 in the usual time period it takes the OTT server 170 to generate a location report 172 based on a measurement report 160, thus indicating that the OTT server 170 has potentially experienced an anomaly. For example, a malfunctioning OTT server 170 may cause slow processing and thus slow response times at the OTT server 170 resulting in the OTT server 170 not being able to generate and transmit a location report 172 within the pre-configured time period from receiving a respective measurement report 160. In another example, a failed OTT server 170 may also result in the OTT server 170 not being able to generate and transmit a location report 172 within the pre-configured time period from receiving a respective measurement report 160.

In one or more embodiments, in response to determining (at operation 204) that the first location report 172 was received within the preconfigured time period from receiving the first measurement report 160, method 200 proceeds to operation 206 where the fault detector 150 correlates the first measurement report 160 with the first location report 172.

At operation 208, the fault detector 150 determines whether the first location report 172 corresponds to the first measurement report 160. In other words, the fault detector 150 determines whether the first location report 172 was determined based on the first measurement report 160. In response to determining that the first location report 172 does not corresponds to the first measurement report 160, method 200 proceeds to operation 210 where the fault detector 150 determines that the OTT server has experienced an anomaly. On the other hand, in response to determining that the first location report 172 corresponds to the first measurement report 160, the fault detector 150 determines that the OTT server 170 is operating normally and method 200 ends here.

As described above, when the fault detector 150 receives a location report 172 within the pre-configured time period from receiving a measurement report 160, the fault detector 150 may be configured to correlate the location report 172 with the measurement report 160 and determine whether the OTT server 170 has experienced an anomaly based on the correlation. For example, the fault detector 150 may correlate the location report 172 with the measurement report 160 to determine whether the location report 172 was generated based on the measurement report 160. Correlating the location report 172 with the measurement report 160 may include extracting the interaction IDs 162 from the location report 172 and the measurement report 160 and comparing the extracted interaction IDs 162 to determine whether both the location report 172 and the measurement report 160 include the same interaction ID 162. As described above, the OTT server 170 includes the same interaction ID 162 of the respective measurement report 160 based on which the location report 172 is generated. Thus, matching interaction IDs 162 between the location report 172 and the measurement report 160 indicates that the location report 172 was generated based on the measurement report 160. Thus, when the location report 172 and the measurement report 160 are found to include the same interaction ID 162, the fault detector 150 determines that the location report 172 was generated based on the measurement report 160. On the other hand, when the location report 172 and the measurement report 160 are found to include different interaction IDs 162, the fault detector 150 determines that the location report 172 was not generated based on the measurement report 160.

In one or more embodiments, in response to determining based on the correlation of the location report 172 with the measurement report 160 that the location report 172 was generated based on the measurement report 160, the fault detector 150 may be configured to determine that the OTT server 170 is operating normally. On the other hand, in response to determining based on the correlation that the location report 172 was not generated based on the measurement report 160, the fault detector 150 may be configured to determine that the OTT server 170 has experienced an anomaly. For example, a malfunctioning OTT server 170 may cause slow processing and thus slow response times at the OTT server 170. Slow response time at the OTT server 170 may cause the OTT server 170 to generate a location report 172 after another measurement report 160 has already been transmitted by the test UE 110a. This means that the location report 172 generated by the OTT server 170 is based on an older measurement report 160 generated by the test UE 110a. Since the location report 172 is based on an older measurement report 160, the interaction ID 162 included in the location report 172 does not match with the interaction ID 162 included in the most recent measurement report 160 transmitted by the test UE 110a. Thus, a mismatch in interaction IDs 162 between a most recent measurement report 160 received at the fault detector 150 and a location report 172 received after the most recent measurement report 160 may indicate that the OTT server 170 has experienced an anomaly.

At operation 212, in response to determining that the OTT server 170 has experienced an anomaly, the fault detector 150 generates and transmits an alert message 166 to a service node 192, wherein the alert message 166 indicates that the OTT server 170 has experienced an anomaly.

As described above, the fault detector 150 may be configured to generate an alert message 166 in response to determining that the OTT server 170 has experienced an anomaly. The alert message 166 may include an indication the OTT server 170 has experienced an anomaly and may further include information relating to the anomaly. For example, the fault detector 150 may include in the alert message 166 information relating to what caused the fault detector 150 to determine that the OTT server 170 is experiencing an anomaly. For example, the alert message 166 may indicate that a location report 172 was not received within the pre-configured time period from receiving a measurement report 160. In another example, the alert message 166 may indicate that the interaction IDs 162 do not match between a location report 172 and a most recent measurement report 160. The fault detector 150 may be configured to transmit alert messages 166 to a service node 192 where network technicians may be employed to investigate the nature of the anomaly at the OTT server 170 and resolve the anomaly. In an alternative or additional embodiment, the service node 192 may employ software programs that monitor and measure several performance related metrics related to the OTT server 170 and identify an anomaly based on the collected metrics. For example, the OTT server 170 may employ several sensors that are configured to measure respective metrics such as temperature, power surges, processing speed, CPU health etc. Once a particular anomaly is identified, the service node may run resolution software scripts to resolve the identified anomaly. For example, when overheating of the OTT server 170 is detected, the service node 192 may divert some data traffic to a different server to ease processing load at the OTT server 170. The reduced load may improve processing performance of the OTT server 170 and reduce heat.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
an over-the-top (OTT) server configured to receive one or more measurement reports from User Equipment (UEs) that initiated a wireless emergency call or a wireless emergency test call;
an emergency server configured to connect the wireless emergency call or the wireless emergency test call placed by each of the UEs to a Public Safety Answering Point (PSAP) of a plurality of PSAPs; and
a processor communicatively coupled to the OTT server and the emergency server, wherein the processor is configured to:
receive, from a cellular network via a data network, a first measurement report of the one or more measurement reports transmitted by a first UE as part of the wireless emergency test call initiated by the first UE, wherein:
the first measurement report includes a first geolocation of the first UE;
the OTT server is configured to generate a first location report based on the first measurement report;
the first location report comprises a first geographical address of the first UE determined based at least on the first measurement report; and
the wireless emergency test call is configured to test location-based routing of wireless emergency calls by the emergency server, wherein the location-based routing comprises connecting a wireless emergency call made by a UE to a PSAP selected based on the geographical address of the UE;
determine that the first location report corresponding to the first measurement report and including the first geographical address of the first UE is not received from the emergency server within a preconfigured time period from receiving the first measurement report from the first UE, wherein the emergency server is configured to receive the first location report from the OTT server and select a first PSAP based on the first geographical address of the first UE included in the first location report;
in response to determining that the first location report corresponding to the first measurement report is not received from the emergency server, determine that the OTT server has experienced an anomaly; and
in response to determining that the OTT server has experienced an anomaly, transmit an alert message to a service node, wherein the alert message indicates that the OTT server has experienced an anomaly.

2. The system of claim 1, wherein the processor is further configured to:
receive, from the cellular network via the data network, a second measurement report transmitted by the first UE as part of a second emergency test call initiated by the first UE, wherein the second measurement report includes a second geolocation of the UE;
receive from the emergency server, a second location report corresponding to the second measurement report, wherein the second location report comprises a second geographical address of the first UE generated by the OTT server based at least in part on the second measurement report;
correlate the second measurement report with the second location report to determine whether the second location report was generated based on the second measurement report; and
in response to determining that the second location report was generated based on the second measurement report, determine that the OTT server is operating normally.

3. The system of claim 2, wherein:
the second measurement report transmitted by the first UE comprises a first interaction ID identifying transmission of the second measurement report by the first UE;
the OTT server is configured to include the first interaction ID in the second location report transmitted to the emergency server; and
the processor is further configured to correlate the second measurement report with the second location report by:
extracting the first interaction ID from the second measurement report;
extracting a second interaction ID from the second location report;
comparing the first interaction ID to the second interaction ID;
determining, based on the comparing, that the second interaction ID is same as the first interaction ID; and
in response to determining that the second interaction ID is same as the first interaction ID, determining that the second location report was generated based on the second measurement report.

4. The system of claim 1, wherein the processor is further configured to:
receive, from the cellular network via the data network, a second measurement report transmitted by the first UE as part of a second emergency test call initiated by the first UE, wherein the second measurement report includes a second geolocation of the UE;
receive from the emergency server, a second location report corresponding to the first UE, wherein the second location report comprises a second geographical address of the first UE;
correlate the second measurement report with the second location report to determine whether the second location report was generated based on the second measurement report;
in response to determining that the second location report was not generated based on the second measurement report, determine that the OTT has experienced an anomaly; and
in response to determining that the OTT server has experienced an anomaly, transmit a second alert message to the service node, wherein the second alert message indicates that the OTT server has experienced an anomaly.

5. The system of claim 4, wherein the processor is further configured to correlate the second measurement report with the second location report by:
extracting a first interaction ID from the second measurement report;
extracting a second interaction ID from the second location report;
comparing the first interaction ID to the second interaction ID;
determining, based on the comparing, that the second interaction ID does not match with the first interaction ID; and
in response to determining that the second interaction ID does not match with the first interaction ID, determining that the second location report was not generated based on the second measurement report.

6. The system of claim 1, wherein the first geolocation of the first UE is determined by the first UE using a Global Positioning System (GPS).

7. The system of claim 1, wherein the first UE is a test UE configured to initiate emergency test calls periodically.

8. The system of claim 1, wherein each PSAP is associated with one or more regions and the wireless emergency call or the wireless emergency test call initiated by each UE is routed by the emergency server to a particular PSAP that is associated with the geographical region of the UE.

9. The system of claim 1, wherein:
the wireless emergency call is placed by each UE to a designated emergency phone number; and
the emergency test call is placed by each UE to a designated emergency test phone number.

10. A method comprising:
receiving, from a cellular network via a data network, a first measurement report transmitted by a first UE as part of a wireless emergency test call initiated by the first UE, wherein:
the first measurement report includes a first geolocation of the first UE;
an OTT server is configured to generate a first location report based on the first measurement report;
the first location report comprises a first geographical address of the first UE determined based at least on the first measurement report; and
the wireless emergency test call is configured to test location-based routing of wireless emergency calls by an emergency server, wherein the location-based routing comprises connecting a wireless emergency call made by a UE to a Public Safety Answering Point (PSAP)selected based on a geographical address of the UE;
determining that the first location report corresponding to the first measurement report and including the first geographical address of the first UE is not received from the emergency server within a preconfigured time period from receiving the first measurement report from the first UE, wherein the emergency server is configured to receive the first location report from the OTT server and select a first PSAP based on the first geographical address of the first UE included in the first location report;
in response to determining that the first location report corresponding to the first measurement report is not received from the emergency server, determining that the OTT server has experienced an anomaly; and
in response to determining that the OTT server has experienced an anomaly, transmitting an alert message to a service node, wherein the alert message indicates that the OTT server has experienced an anomaly.

11. The method of claim 10, further comprising:
receiving, from the cellular network via the data network, a second measurement report transmitted by the first UE as part of a second emergency test call initiated by the first UE, wherein the second measurement report includes a second geolocation of the UE;
receiving from the emergency server, a second location report corresponding to the second measurement report, wherein the second location report comprises a second geographical address of the first UE generated by the OTT server based at least in part on the second measurement report;
correlating the second measurement report with the second location report to determine whether the second location report was generated based on the second measurement report; and
in response to determining that the second location report was generated based on the second measurement report, determining that the OTT server is operating normally.

12. The method of claim 11, wherein:
the second measurement report transmitted by the first UE comprises a first interaction ID identifying transmission of the second measurement report by the first UE;
the OTT server is configured to include the first interaction ID in the second location report transmitted to the emergency server; and
correlating the second measurement report with the second location report comprises:
extracting the first interaction ID from the second measurement report;
extracting a second interaction ID from the second location report;
comparing the first interaction ID to the second interaction ID;
determining, based on the comparing, that the second interaction ID is same as the first interaction ID; and
in response to determining that the second interaction ID is same as the first interaction ID, determining that the second location report was generated based on the second measurement report.

13. The method of claim 10, further comprising:
receiving, from the cellular network via the data network, a second measurement report transmitted by the first UE as part of a second emergency test call initiated by the first UE, wherein the second measurement report includes a second geolocation of the UE;
receiving from the emergency server, a second location report corresponding to the first UE, wherein the second location report comprises a second geographical address of the first UE;
correlating the second measurement report with the second location report to determine whether the second location report was generated based on the second measurement report;
in response to determining that the second location report was not generated based on the second measurement report, determining that the OTT has experienced an anomaly; and
in response to determining that the OTT server has experienced an anomaly, transmitting a second alert message to the service node, wherein the second alert message indicates that the OTT server has experienced an anomaly.

14. The method of claim 13, wherein correlating the second measurement report with the second location report comprising:
extracting a first interaction ID from the second measurement report;
extracting a second interaction ID from the second location report;
comparing the first interaction ID to the second interaction ID;
determining, based on the comparing, that the second interaction ID does not match with the first interaction ID; and
in response to determining that the second interaction ID does not match with the first interaction ID, determining that the second location report was not generated based on the second measurement report.

15. The method of claim 10, wherein the first geolocation of the first UE is determined by the first UE using a Global Positioning System (GPS).

16. A non-transitory computer-readable medium storing instructions that when executed by a processor causes the processor to:
receive, from a cellular network via a data network, a first measurement report transmitted by a first UE as part of a wireless emergency test call initiated by the first UE, wherein:
the first measurement report includes a first geolocation of the first UE;
an OTT server is configured to generate a first location report based on the first measurement report;
the first location report comprises a first geographical address of the first UE determined based at least on the first measurement report; and
the wireless emergency test call is configured to test location-based routing of wireless emergency calls by an emergency server, wherein the location-based routing comprises connecting a wireless emergency call made by a UE to a Public Safety Answering Point (PSAP)selected based on a geographical address of the UE;
determine that the first location report corresponding to the first measurement report and including the first geographical address of the first UE is not received from the emergency server within a preconfigured time period from receiving the first measurement report from the first UE, wherein the emergency server is configured to receive the first location report from the OTT server and select a first PSAP based on the first geographical address of the first UE included in the first location report;
in response to determining that the first location report corresponding to the first measurement report is not received from the emergency server, determine that the OTT server has experienced an anomaly; and
in response to determining that the OTT server has experienced an anomaly, transmit an alert message to a service node, wherein the alert message indicates that the OTT server has experienced an anomaly.

17. The non-transitory computer-readable medium of claim 16, wherein the instructions further cause the processor to:
receive, from the cellular network via the data network, a second measurement report transmitted by the first UE as part of a second emergency test call initiated by the first UE, wherein the second measurement report includes a second geolocation of the UE;
receive from the emergency server, a second location report corresponding to the second measurement report, wherein the second location report comprises a second geographical address of the first UE generated by the OTT server based at least in part on the second measurement report;
correlate the second measurement report with the second location report to determine whether the second location report was generated based on the second measurement report; and
in response to determining that the second location report was generated based on the second measurement report, determine that the OTT server is operating normally.

18. The non-transitory computer-readable medium of claim 17, wherein:
the second measurement report transmitted by the first UE comprises a first interaction ID identifying transmission of the second measurement report by the first UE;
the OTT server is configured to include the first interaction ID in the second location report transmitted to the emergency server; and
correlating the second measurement report with the second location report comprises:
extracting the first interaction ID from the second measurement report;
extracting a second interaction ID from the second location report;
comparing the first interaction ID to the second interaction ID;
determining, based on the comparing, that the second interaction ID is same as the first interaction ID; and
in response to determining that the second interaction ID is same as the first interaction ID, determining that the second location report was generated based on the second measurement report.

19. The non-transitory computer-readable medium of claim 16, wherein the instructions further cause the processor to:
receive, from the cellular network via the data network, a second measurement report transmitted by the first UE as part of a second emergency test call initiated by the first UE, wherein the second measurement report includes a second geolocation of the UE;
receive from the emergency server, a second location report corresponding to the first UE, wherein the second location report comprises a second geographical address of the first UE;
correlate the second measurement report with the second location report to determine whether the second location report was generated based on the second measurement report;
in response to determining that the second location report was not generated based on the second measurement report, determine that the OTT has experienced an anomaly; and
in response to determining that the OTT server has experienced an anomaly, transmit a second alert message to the service node, wherein the second alert message indicates that the OTT server has experienced an anomaly.

20. The non-transitory computer-readable medium of claim 19, wherein correlating the second measurement report with the second location report comprises:
extracting a first interaction ID from the second measurement report;
extracting a second interaction ID from the second location report;
comparing the first interaction ID to the second interaction ID;
determining, based on the comparing, that the second interaction ID does not match with the first interaction ID; and
in response to determining that the second interaction ID does not match with the first interaction ID, determining that the second location report was not generated based on the second measurement report.
